(19) United States
(12) Patent Application Publication
(10) Pub. No.: US 2011/0162744 A1
(43) Pub. Date: Jul. 7, 2011

(54) Device for piloting by means of a substantially incompressible fluid

(75) Inventors: Graziano Levoni, Modena (IT); Imer Iori, Quattro Castella (IT)

(73) Assignee: NEM S.P.A.

(21) Appl. No.: 12/929,060

(22) Filed: Dec. 28, 2010

(30) Foreign Application Priority Data
Jan. 5, 2010 (EP) 10425001.4

(51) Int. Cl. F15C 1/06

(52) U.S. Cl. 137/833

(57) ABSTRACT

A device for piloting by means of a substantially incompressible fluid, comprising a two-way flow control valve which operates along a piloting line and has at least one first port and one second port, which are adapted to be connected, respectively, to elements for supplying a substantially incompressible fluid under pressure and to a fluid-operated element to be piloted by the piloting line and choke elements arranged in parallel to the flow control valve along a bypass duct which is closed in a loop on the piloting line, the flow control valve being actuated for closing by the pressure at the second port, the calibration pressure value at which the flow control valve closes being at most equal to the actuation pressure value of the element to be piloted.

The present invention relates to a device for piloting by means of a substantially incompressible fluid.

### BACKGROUND OF THE INVENTION

It is known to use fluid-operated devices having a plurality of operational configurations, in which transition from one configuration to another is actuated by using a pressurized substantially incompressible fluid, which is fed through a piloting line derived from a main circuit.

In some applications there is the need to attenuate the pressure along such piloting line, so as to stabilize the operation of the piloted element independently of oscillation or instability of the pressure in the main circuit. A typical application of this type, for example, is the one related to a hydraulic circuit for actuating an actuator for the lifting and lowering of a load, which has a first working duct connected to the actuator chamber that actuates load lowering and a second working duct connected to the actuator chamber that actuates load lifting, and along which there is an overcenter valve for controlling the flow-rate during the discharge step, which operates by being normally closed and is actuated to open by a piloting line derived from the first working duct.

For this purpose it is known to provide, along the piloting line, a fixed or adjustable choke, which attenuates the pressure signal sent to the piloted element.

In the chart of FIG. 1, the curves p_{UP}, p_{DOWN} and p_{PIL} respectively plot the variation over time of the pressure in the lifting chamber and in the lowering chamber of the actuator and of the pressure in the piloting chamber of the overcenter valve during the load lowering step. The curve p_{PIL} schematically plots the rise over time of the pressure in the piloting chamber of the overcenter valve, which is obtained by means of a piloting line provided with a choke; the inclination of such curve depends on the degree of attenuation applied by the choke. This pressure increases until the pressure value p_{AZ} is reached which opens the overcenter valve. The pressure value p_{PIL} increases in a linear manner until the pressure p_{DOWN} in the lowering chamber starts to decrease. The pressure difference reduction to which the choke is subjected causes a variation of the pressure gradient referred to p_{PIL}.

For demanding applications, because of the difficulty of obtaining adequately small choke holes, the choke is provided by a capillary duct which is formed along the helicoid of the thread in a screw-and-nut coupling.

However, the signal attenuation efficiency obtained by using a choke is strongly influenced by the viscosity of the fluid that flows through it, which is variable depending on the operating conditions.

Moreover, the use of a piloting line provided with a choke to actuate a piloted element causes a considerable delay in the intervention of such element with respect to the command imparted by the operator, who does not obtain a prompt response by the circuit, which delay moreover varies depending on the operating conditions.

In order to obviate these drawbacks, it is known to provide piloting devices that bypass the choke during the initial step of pressurization of the piloting chamber of the piloted element.

An example of this type of application is known from EP 1178219 B1, which discloses a hydraulic control device for a piloting pressure which substantially consists of a piloting line interposed between a supply and an element to be piloted and along which there is a two-way two-position flow control valve, which is kept open by a spring which acts on the associated obturator and is actuated to close by the pressure upstream of such valve, when such pressure reaches such a value that the force produced by the pressure that acts on the obturator cross-section overcomes the resistance of such spring. Moreover, there is in parallel a closed-loop bypass duct on the piloting line, and a choke is provided along the duct.

The flow control valve is, ideally, calibrated so that the pressure value p_{TAR} that determines its closing is slightly lower than the pressure value p_{AZ} for which the piloted element is actuated.

By supplying, therefore, the piloting line, at the beginning of the step for filling the piloting chamber of the piloted element, the flow passes substantially through the flow control valve, which is still open, achieving faster pre-filling; when the pressure value p_{TAR} is reached at the inlet of the valve, such valve closes and the flow continues to pass exclusively through the bypass duct and the choke, resulting, in the final step, in a more gradual filling of the piloting chamber, until the pressure value p_{AZ} that determines the actuation of the piloted element is reached.

Inside an actuation circuit of an actuator for the lifting and lowering of a load, such piloting device is interposed between the first working duct and the piloting chamber of the overcenter valve.

With reference to such application, in FIG. 2 the curves p_{UP}, p_{DOWN} and p_{PIL} plot the variation over time, respectively, of the pressure in the lifting chamber and in the lowering chamber of the actuator and of the pressure in the piloting chamber of the overcenter valve in the load lowering step.

In particular, the curve p_{PIL} plots schematically the operation of the device cited above: in the pre-filling step, the piloting pressure at the outlet of the flow control valve has an increase which is equal to the input pressure. When the calibration pressure value p_{TAR} is reached at the flow control valve inlet, the valve closes; as a consequence of the closing, the pressure in the piloting chamber, after an initial drop, re-increases as a consequence of the opening of the overcenter valve.

It is noted that the actual behavior of the piloting device shows a reduction of the pressure value p_{PIL} that follows the closing of the flow control valve due to the fact that the increase in the pressure value p_{UP}, which is the result of the pressurization of the first working duct, induces a micro-movement of the sealing piston of the overcenter valve in the opening direction, causing an increase in the volume of the piloting chamber and, therefore, the reduction of the pressure value p_{PIL} supplied through the choke.

Although this solution allows a reduction of the time necessary to reach, in the piloting chamber of the piloted element, the pressure value p_{AZ} that causes the actuation of the piloted element, with respect to the case in which only the choke is used, this solution is not free from drawbacks, either.

In fact, when the flow control valve closes, the actual pressure value downstream of such valve, which is equivalent to the pressure established in the piloting chamber, is lower than the value p_{TAR} detected upstream, which causes its closing. The difference Δ between the value p_{TAR} and the value actually obtained of the piloting chamber of the piloted element at the instant when the flow control valve closes is at least equal to the load losses undergone by the flow in passing through the valve itself. Moreover, the pressure value obtained in the piloting chamber when the flow control valve closes is not constant, because the extent of the load losses varies depending on the operating conditions (temperature, actuation speed), and is influenced by the presence of compressible volumes mixed with the incompressible working fluid of the system.

Therefore, the time required to complete piloting chamber pressurization and thus achieve actuation of the piloted element after the closure of the flow control valve is not constant and cannot be determined exactly in advance, since it is a function of the difference in pressure that must yet be supplied through the bypass duct and the choke when the flow control valve is closed, which, as mentioned above, is variable.

Even in this case, therefore, the operator's command is not followed by a fast and specific response of the circuit, with a consequent unsatisfactory performance for the operator.

Moreover, these known applications (the one with only the choke and the one with parallel flow control valve and choke) are unable to avoid the occurrence of pressure peaks in the main circuit if the degree of attenuation of the choke is excessive.

In particular, if these piloting devices are inserted in a hydraulic circuit for the actuation of an actuator for lifting and lowering a load of the type cited above, pressure peaks can occur at the inlet of the piloting line and therefore in the lowering chamber of the actuator, as well as in the lifting chamber in case of an excessive delay in opening of the overcenter valve during the load lowering step, with a consequent risk of early wear of the actuator. These increases are highlighted in FIGS. 1 and 2 by the curves designated by p_{UP} and p_{DOWN}. In particular, the p_{DOWN} curves in FIGS. 1 and 2 point out, in the load lowering step, the trend over time of the pressure upstream of the piloting device and therefore at the lowering chamber of the actuator, obtained by using a piloting line provided with just a choke or with a flow control valve and a choke in parallel, respectively. Moreover, in FIGS. 1 and 2 the corresponding curves p_{UP} point out, in the load lowering step, the trend over time of the pressure of the lifting chamber of the actuator obtained by using a piloting line provided with just a choke or with a flow control valve and a choke in parallel, respectively.

The curves p_{UP} and p_{DOWN} of FIG. 2, in particular, show a peak of the associated pressure values following the closure of the flow control valve.

### SUMMARY OF THE INVENTION

The aim of the present invention is to eliminate the above cited drawbacks of the background art, by providing a device for piloting by means of a substantially incompressible fluid that makes it possible to reduce the time needed to achieve the actuation of the piloted element and at the same time to ensure a specific and repeatable response of the circuit regardless of the operating conditions.

Within this aim, an object of the present invention is to avoid the occurrence of pressure peaks in the main circuit in which the device is inserted, in order to protect the corresponding elements and avoid compromising their functionality and lifespan.

Another object of the present invention is to be reliable and durable over time.

Another object of the present invention is to have a structure which is simple, relatively easy to provide in practice, safe to use, effective in operation, and relatively inexpensive.

This aim and these and other objects, that will become better apparent hereinafter, are achieved by the present device for piloting by means of a substantially incompressible fluid, comprising a two-way flow control valve that operates along a piloting line and has at least one first port and one second port, which are adapted to be connected, respectively, to means for supplying a substantially incompressible fluid under pressure and to a fluid-operated element to be piloted by means of said piloting line and choke means arranged in parallel to said flow control valve along a bypass duct which is closed in a loop on said piloting line, characterized in that said flow control valve is actuated for closing by the pressure at the second port, the calibration pressure value at which the flow control valve closes being at most equal to the actuation pressure value of the element to be piloted.

### BRIEF DESCRIPTION OF THE DRAWINGS

Further characteristics and advantages of the present invention will become better apparent from the following detailed description of some preferred but not exclusive embodiments of a device for piloting by means of a substantially incompressible fluid, illustrated by way of non-limiting example in the accompanying drawings, wherein:

FIG. 1 is a schematic chart of the variation over time of the pressure in the lifting chamber p_{UP} and in the lowering chamber p_{DOWN} of the actuator and of the pressure p_{PIL} in the piloting chamber of the overcenter valve in the load lowering step, which is obtained in a hydraulic circuit for the actuation of an actuator for lifting and lowering a load which uses a piloting line of the overcenter valve of a known type and provided only with a choke;

FIG. 2 is a schematic chart which plots the variation over time of the pressure in the lifting chamber p_{UP} and in the lowering chamber p_{DOWN} of the actuator and of the pressure p_{PIL} in the piloting chamber of the overcenter valve in the load lowering step, which is obtained in a hydraulic circuit for actuating an actuator for lifting and lowering a load which uses a piloting line for the overcenter valve of a known type and provided with a flow control valve and a choke in parallel;

FIGS. 3, 4 and 5 are respective schematic charts that plot the variation over time of the pressure in the lifting chamber p_{UP} and in the lowering chamber p_{DOWN} of the actuator and of the pressure p_{PIL} in the piloting chamber of the overcenter valve in the load lowering step, which is obtained in a fluid-operated circuit for the actuation of an actuator for lifting and lowering a load which uses a piloting device according to the invention, respectively according to first, second and third embodiments;

FIG. 6 is a circuit diagram of the first embodiment of the piloting device according to the invention;

FIG. 7 is a circuit diagram of the piloting device of FIG. 6 inserted in a fluid-operated circuit for actuating an actuator for lifting and lowering a load;

FIG. 8 is a circuit diagram of the second embodiment of the piloting device according to the invention;

FIG. 9 is a schematic longitudinal sectional view of a possible embodiment of the piloting device of FIG. 8;

FIG. 10 is a detail view of the obturator of FIG. 9;

FIG. 11 is a circuit diagram of the third embodiment of the piloting device according to the invention;

FIG. 12 is a schematic longitudinal sectional view of a possible embodiment of the device of FIG. 11.

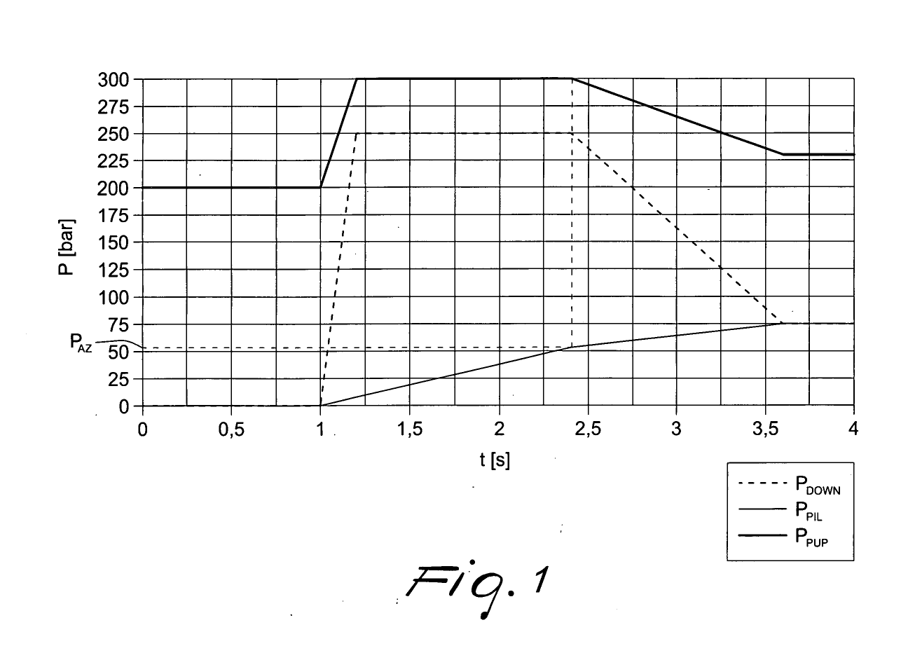

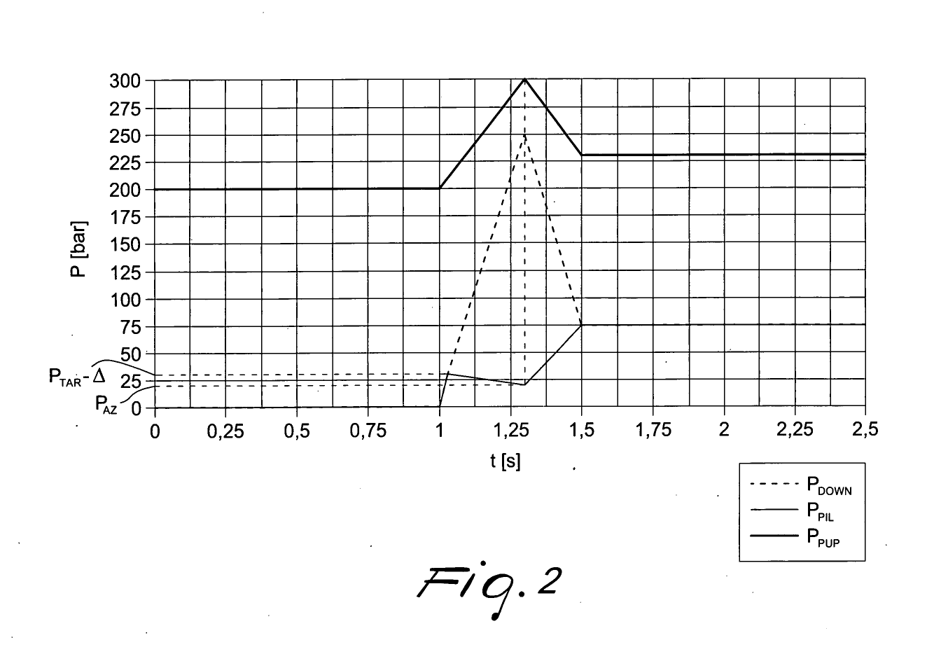

### DESCRIPTION OF THE PREFERRED EMBODIMENTS

With reference to the figures, the reference numeral 1 generally designates a device for piloting by means of a substantially incompressible fluid of the hydraulic oil-type for power transmission.

The device 1 comprises a two-way flow control valve 2 with at least two positions, which operates along a piloting line 3 and is provided with at least one first port 4 and at least one second port 5 which are designed, in use, to be placed in fluid communication, respectively, with means for supplying a substantially incompressible fluid under pressure and with a fluid-operated body to be piloted by means of such piloting line.

The device 1 further comprises fixed or adjustable choke means 6, which are arranged in parallel to the flow control valve 2 along a bypass duct 7 which is closed in a loop on the piloting line 3. The flow control valve 2 is actuated for closing by the pressure at the second port 5, the calibration pressure value p_{TAR} at which such valve closes being at most equal to the actuation pressure value p_{AZ} of the element to be piloted.

More particularly; the actuation pressure value p_{AZ} can be determined experimentally in relation to the specific application and corresponds to the pressure value along the piloting line 3 that causes actuation of the piloted element in conditions of maximum load acting on such element.

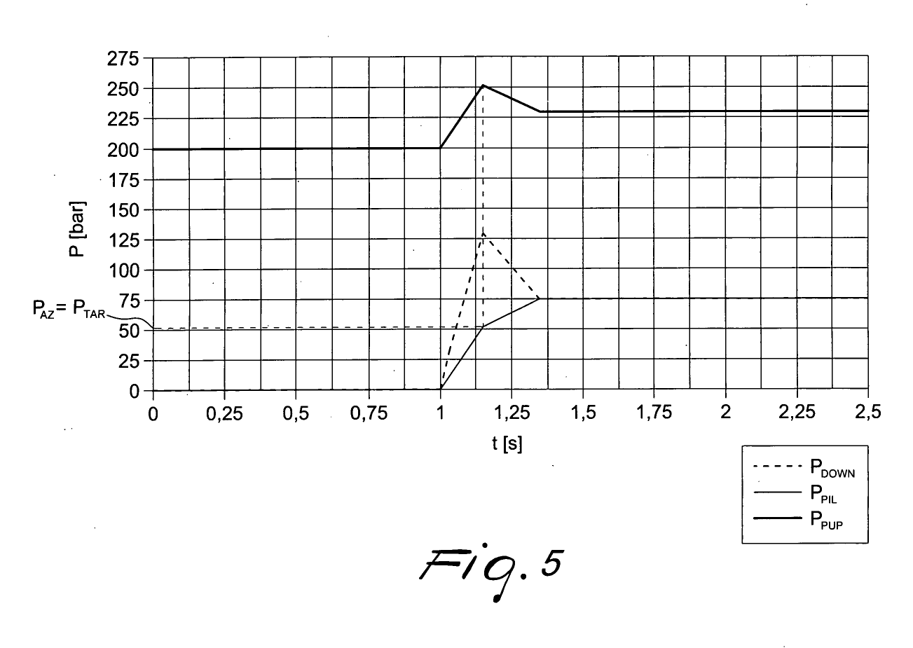

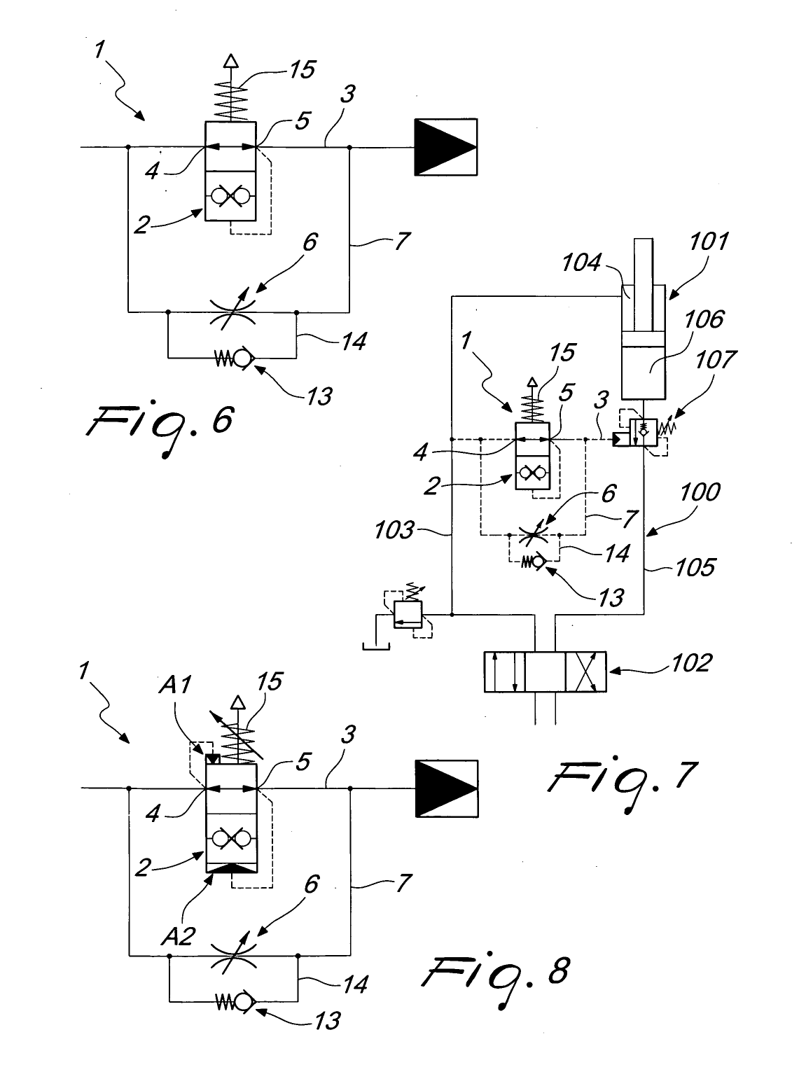

With reference to FIG. 7, the device 1 can be applied within a traditional fluid-operated circuit 100 for the actuation of an actuator 101 for lifting and lowering a load which is connected to its stem and is not shown. The circuit 100 is provided with means 102 for distributing a substantially incompressible fluid under pressure, from which branch off a first working duct 103, which is a to a first chamber 104 of the actuator 101, which is adapted to actuate the lowering of the load if supplied, and a second working duct 105, which is connected to a second chamber 106 of the actuator 101, which is adapted to actuate the lifting of the load if supplied. The circuit 100 is provided, moreover, with an overcenter valve 107, which is normally closed, is arranged along the second working duct 105 and can be opened for discharging the second chamber 106 in the load lowering step.

The device 1 can therefore be applied for driving the opening of the overcenter valve 107 and can be interposed between the first working duct 103 and such valve, with the first port 4 and the second port 5 arranged in fluid communication, respectively, with the first working duct 103 and with the piloting chamber of the overcenter valve 107. In this case, the calibration pressure value p_{TAR} detected at the second port 5 that determines the closure of the flow control valve 2 is at most equal to the pressure value p_{AZ} for actuating the opening of the overcenter valve 107.

In this configuration, the supply means are represented by the distribution means 102 and by the first working duct 103, while the fluid-operated element to be piloted consists in the overcenter valve 107.

However, different applications of the device 1 are not excluded.

The flow control valve 2 comprises a valve body 8 in which there is an axial sliding seat 9 of an obturator 10, which is connected to the first port 4 and the second port 5 and along which an annular sealing seat 11 is provided which is interposed between such ports.

Advantageously, the second port 5 is arranged at a first end of the obturator 10 and preferably faces it so that the pressure p_{PIL} at the second port, which corresponds to the pressure in the piloting chamber of the element to be piloted, acts constantly on the obturator 10 in the direction for closing the flow control valve 2.

Preferably, the first port 4 is arranged laterally with respect to the obturator 10, on the opposite side of the second port 5 with respect to the annular seat 11, and the second end of the obturator, which lies opposite the first one, is subject to ambient pressure or in any case to a pressure which is negligible with respect to the pressures that act at the ports 4 and 5.

More particularly, the axial seat 9 has two regions which are isolated from each other by a sealing ring 9a, a first region at the second end of the obturator 10 being ventilated, i.e., at ambient pressure, and a second region at the first end of the obturator being pressurized.

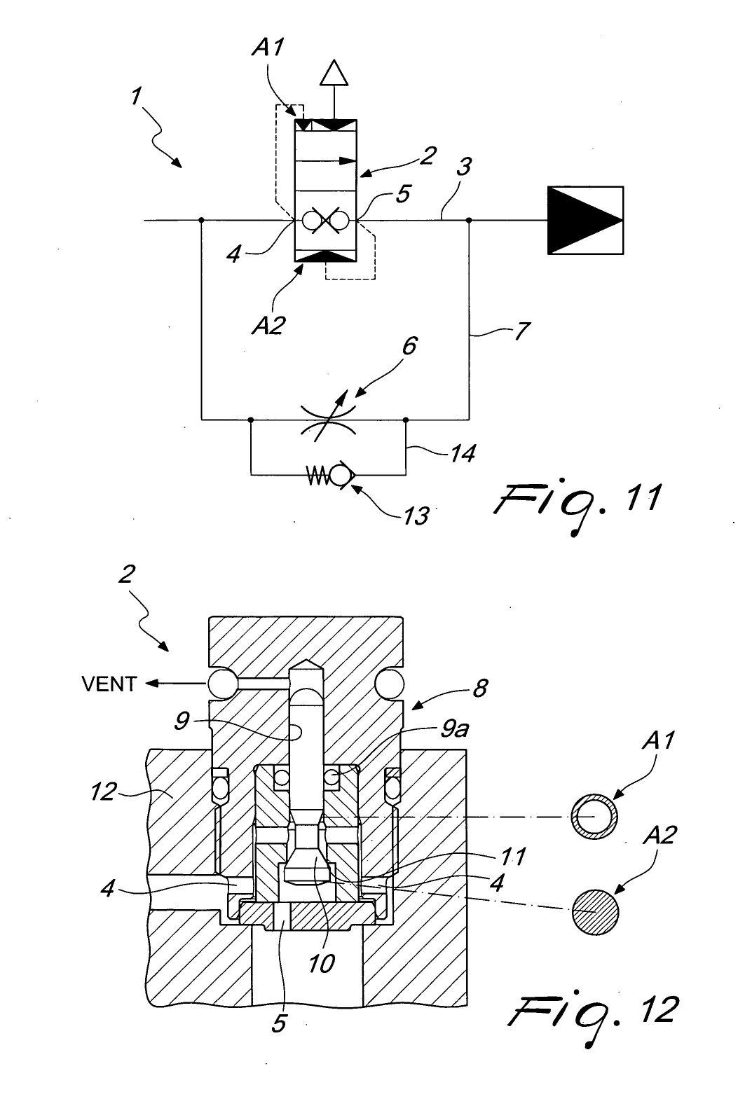

In FIGS. 9 and 12, the flow control valve 2 shown has a cartridge-like shape and has therefore an external portion of the valve body 8 which is threaded for mating with a corresponding seat provided on a monoblock 12, which is shown only partially and allows integration of the other components of the device 1 as well as the element piloted by such device. However, it is not excluded that the device 1 might be provided as a separate assembly and connected to the element to be piloted by means of external ducts.

Advantageously, the obturator 10 is provided monolithically.

In view of the above, and due to the particular arrangement of the first port 4 and of the second port 5 with respect to it, the flow control valve 2 ensures a bidirectional seal in closure.

The device 1 is preferably provided with a check valve 13 arranged in parallel to the flow control valve 2 along a return duct 14 which is closed in a loop on either the piloting line 3 or the bypass duct 7, which can be opened in the direction for the fluid flow from the piloted element toward the supply means in order to allow the discharge of the piloting chamber of such element, so as to restore the operating condition prior to the actuation by means of the device 1.

In the embodiments shown, the return duct 14 is closed on the bypass duct 7.

However, it is not excluded that the return duct 14 might branch off from the piloting line 3 or from the bypass duct 7 upstream of the check valve 13, leading, at the other end, to a separate device for the discharge and/or recovery of the fluid evacuated from the piloting chamber.

In a first possible embodiment (FIGS. 3, 6 and 7), the device 1 has first elastic compression means 15 which are interposed between the valve body 8 and the second end of the obturator 10, at the ventilated area of the axial seat 9, which act in the direction for spacing the obturator from the annular seat 11.

In this manner, the flow control valve 2 normally operates in the open configuration, allowing bidirectional flow from the first port 4 toward the second port 5 and vice versa, and the preloading of the first elastic means 15, preferably of the adjustable type, determines the calibration pressure value p_{TAR} of such valve.

The calibration pressure value p_{TAR} can be lower than, or equal to, the actuation pressure value p_{AZ} of the fluid-operated element to be piloted. In this manner it is possible to obtain fast and controlled pre-filling of the piloting chamber of the fluid-operated element to be piloted up to the set value of p_{TAR} and complete the pressurization of the chamber up to the value p_{AZ} by means of the bypass duct 7 and the choke means 6.

With reference to the curve p_{PIL} of FIG. 3, it can be seen that the increase in the pressure in the piloting chamber of the fluid-operated element to be piloted is rather fast in the pre-filling step until the exact value p_{TAR} is reached, i.e., while the flow control valve 2 is open, and remains constant following the closure of the valve.

Attention is called to the fact that as a consequence of the closure of the flow control valve 2, the pressure p_{PIL} remains constant at the value of p_{TAR} until the peak value for the pressure p_{DOWN} is reached upon opening the overcenter valve 107.

Advantageously, in fact, the pressure reduction at the second port 5, which is determined, following the closure of the flow control valve 2, by the increase in pressure in the second chamber 106 caused by the pressurization of the first chamber 104, causes the reopening of the valve in order to maintain the pressure at the second port 5 at the value p_{TAR}.

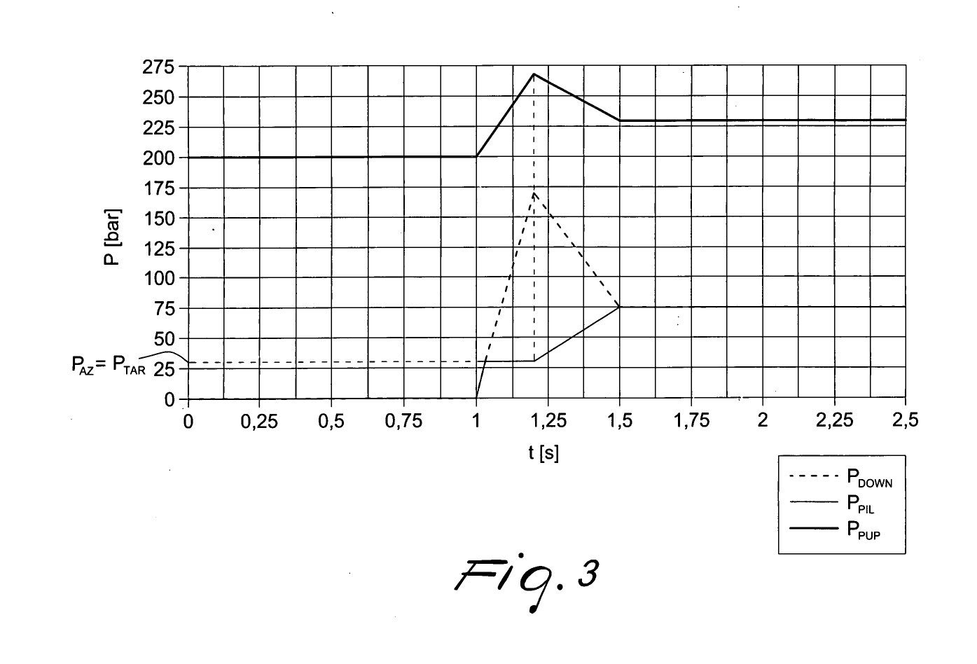

In a second embodiment (FIGS. 4, 8, 9 and 10) of the device 1, which is a further improvement with respect to the preceding one, the flow control valve 2, in addition to having the first elastic means 15, is provided with an obturator 10 which is shaped so as to have first and second reaction surfaces which have different extensions and are arranged axially so that in the closed configuration they are influenced respectively by the pressure at the first port 4, i.e., the supply pressure, and by the pressure at the second port 5, which is equivalent to the pressure in the piloting chamber of the piloted element.

According to this embodiment, the flow control valve 2, which operates in normally open conditions and closes when the calibration pressure value p_{TAR} is reached at the second port 5, is adapted to reopen when a preset ratio is reached between the pressures at the first port and at the second port, respectively 4 and 5, depending on the ratio between the extension of the second surface and of the first surface.

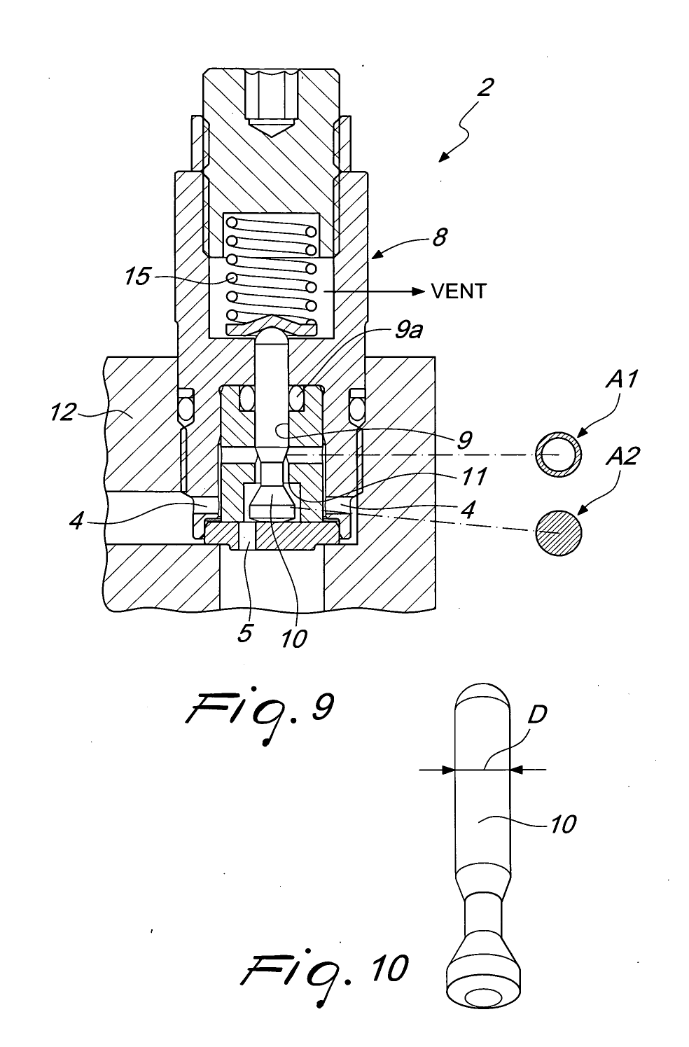

The first surface A₁ coincides with the annular area obtained from the difference between the area defined by the annular seat 11 and the area that corresponds to the larger diameter of the stem of the obturator 10 (designated by D in FIG. 10), while the second surface A₂ corresponds to the area defined by the annular seat 11.

The relation that determines the reopening of the flow control valve 2 if the device 1 is inserted in the circuit 100 described above is, therefore, as follows:

p_{DOWN}·A₁+F_{SPRING}>p_{PIL}·A₂

where p_{DOWN} is the pressure value at the first port 4 that is equivalent to the pressure value supplied to the first chamber 104; p_{PIL} is the pressure value at the second port 5 that is equivalent to the pressure value in the piloting chamber of the overcenter valve 107; F_{SPRING} is the reaction of the first elastic means 15; A₁ and A₂ correspond to the areas defined above.

In this manner, the flow control valve 2 can reopen, after closing upon reaching the calibration pressure value p_{TAR} at the second port 5, avoiding the occurrence of pressure peaks upstream and downstream of the flow control valve and therefore in the chambers 104 and 106 of the actuator 101, as shown by the chart of FIG. 4.

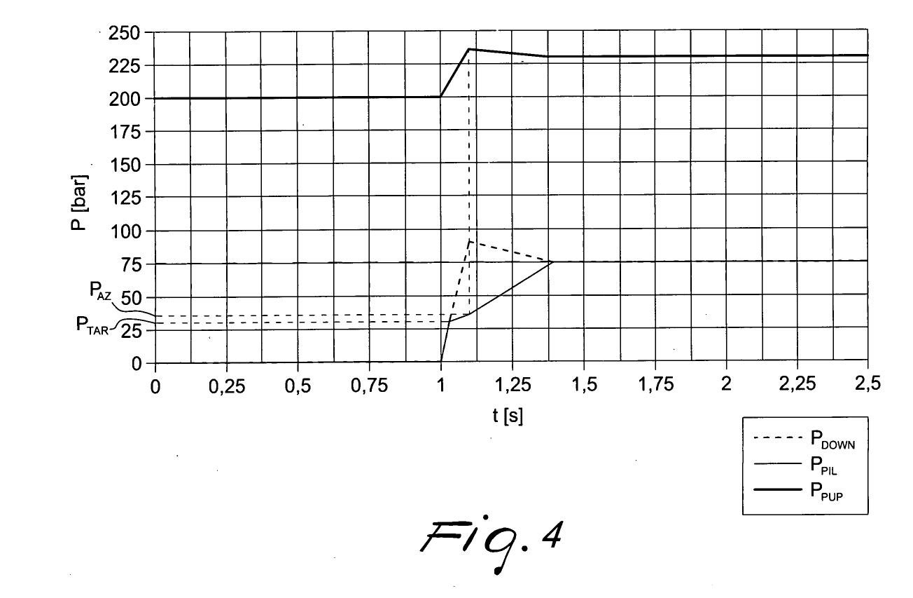

In a third embodiment (FIGS. 5, 11 and 12) of the device 1, the first elastic means 15 are absent in the flow control valve 2. The obturator 10 is still shaped so as to form the first and second surfaces, respectively A₁ and A₂, as defined above. In this case it is necessary for the second surface A₂ to have a larger extension than the first surface A₁ so as to keep the flow control valve 2 normally in the closed configuration even with relatively low residual pressures at the second port 5, and to allow exclusively the flow of the fluid from the first port 4 to the second port 5 in the open configuration.

With reference to the application of the device 1 within a circuit 100 of the above cited type, the relation that determines the closure of the flow control valve 2 and the holding of the closed configuration is as follows:

p_{DOWN}·A₁<p_{PIL}·A₂

where the symbols used are the same as cited above.

In order to ensure holding of the closed configuration even with slight increases in the pressure value at the first port 4, it is possible to provide second elastic compression means, not shown, which are interposed between the valve body 8 and the first end of the obturator 10 and operate in the direction of approach of the obturator toward the annular seat 11.

In the preceding relation, the reaction of such second elastic means would be added to the resultant of the pressure p_{PIL} that acts on the second surface A₂.

Obviously, the flow control valve 2 opens when the above-mentioned relation is inverted.

According to this embodiment, the flow control valve 2 is in the closed configuration when the piloting line 3 begins to be supplied and the fluid passes exclusively through the bypass duct 7 and the choke means 6 pre-load the piloting chamber of the fluid-operated element to be piloted. When the pressure value at the first port 4 is such as to meet the opening condition of the flow control valve 2, such flow control valve opens, allowing a faster pressurization of the piloting chamber of the element to be piloted until the actuation pressure value p_{AZ} of such element is reached.

In this condition, the calibration pressure value p_{TAR} of the flow control valve that causes its closure is substantially equal to the actuation pressure value p_{AZ}, minus slight load losses.

This behavior is highlighted by the curve p_{PIL} of FIG. 5, which shows an increase of the pressure value p_{PIL} which is proportional to the pressure value p_{DOWN} according to the ratio between the surfaces A₂/A₁, in the initial supply step of the piloting line 3, and a slower increase following the reclosure of the valve because of the decrease of pressure value p_{DOWN}, until the stable value is reached.

This embodiment; too, makes it possible to avoid the occurrence of overpressures in the main circuit in which the device 1 is inserted, due to the ability of the obturator 10 to move along the axial seat 9 as a function of the ratio between the instantaneous pressure values at the ports 4 and 5.

The obturator 10 in fact floats along the axial seat 9 and in practice can assume various positions which are intermediate between the open one and the closed one.

In practice it has been found that the invention described achieves the intended aim and objects and in particular the fact is stressed that the device according to the invention makes it possible to obtain a more controlled response of the piloted element with reaction times which are nonetheless brief due to the fact that the flow control valve is piloted to close by the instantaneous pressure at the second port. Moreover, the embodiments of the device provided with an obturator with differential areas allow a lowering of the pressure peaks in the main circuit, ensuring better operation over time.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements, without thereby abandoning the scope of protection of the appended claims.

The disclosures in European Patent Application No. 10425001.4 from which this application claims priority are incorporated herein by reference.

What is claimed is:

1. A device for piloting by means of a substantially incompressible fluid, comprising a two-way flow control valve which operates along a piloting line and has at least one first port and one second port, which are adapted to be connected, respectively, to means for supplying a substantially incompressible fluid under pressure and to a fluid-operated element to be piloted by means of said piloting line and choke means arranged in parallel to said flow control valve along a bypass duct which is closed in a loop on said piloting line, wherein said flow control valve is actuated for closing by the pressure at the second port, the calibration pressure value at which the flow control valve closes being at most equal to the actuation pressure value of the element to be piloted.

2. The device according to claim 1, further comprising a valve body in which there is an axial seat for the sliding of an obturator, which is connected to said first port and said second port and has an annular sealing seat interposed between said ports, the second port being arranged at a first end of said obturator.

3. The device according to claim 2, wherein said first port is arranged laterally with respect to said obturator, the second end of said obturator, arranged opposite the first one, being subject to ambient pressure.

4. The device according to claim 2, wherein said obturator is provided monolithically.

5. The device according to claim 4, wherein said flow control valve has a bidirectional closure seal.

6. The device according to claim 1, further comprising a check valve, which is arranged in parallel to said flow control valve along a return duct which is closed in a loop on one of said piloting line and said bypass duct, the check valve being openable in the direction of flow of the fluid from the piloted element toward the supply means.

7. The device according to claim 3, further comprising first elastic compression means, which are interposed between said valve body and the second end of said obturator and operate in the direction for spacing said obturator from said annular sealing seat, the flow control valve normally operating in the open configuration.

8. The device according to claim 7, wherein said calibration pressure value at which said flow control valve closes is lower than the actuation pressure value of the element to be piloted.

9. The device according to claim 3, wherein said obturator is shaped so as to form first and second reaction surfaces, which have different extensions and are arranged axially so as to be influenced, in the closed configuration, respectively by the pressure at the first port and the pressure at the second port, the flow control valve being adapted to reopen for a predefined ratio between the pressures at the first port and at the second port, as a function of the ratio between the extensions of the second surface and of the first reaction surface.

10. The device according to claim 9, wherein the ratio between the extensions of said second surface and said first surface is larger than 1 for obtainment of a unidirectional opening operation of said flow control valve, said flow control valve being adapted to allow exclusively the flow of fluid from the first port to the second port and to normally remain in closed conditions.

11. The device according to claim 10, further comprising second elastic compression means, which are interposed between said valve body and said obturator at the first end of said obturator and operate in the direction of approaching the annular sealing seat, the flow control valve operating in normally closed conditions.

12. The device according to claim 1, wherein a calibration pressure value at which said flow control valve closes is substantially equal to the actuation pressure value of the element to be piloted.

13. A circuit for actuating a fluid-operated actuator for lifting and lowering a load, comprising means for the distribution of a substantially incompressible fluid under pressure, from which there branch off a first working duct, which is associated with a first chamber of said actuator which, if supplied, is adapted to actuate the lowering of the load, and a second working duct, which is associated with a second chamber of said actuator which, if supplied, is adapted to actuate the lifting of the load, and an overcenter valve, which is normally closed and is arranged along said second working duct and can be opened for discharging said second chamber during the load lowering step, further comprising a piloting device according to one or more of claims 1 to 12, which is interposed between said first working duct and said overcenter valve, with said first port and said second port associated respectively with said first working duct and with the overcenter valve, the calibration pressure value of the flow control valve being at most equal to the pressure value for actuation of the opening of the overcenter valve.
